(19) United States
(12) Patent Application Publication
(10) Pub. No.: US 2022/0354307 A1
(43) Pub. Date: Nov. 10, 2022

(54) MACHINE FOR PREPARING JUICE FROM A FROZEN FOOD PREPARATION

(71) Applicant: IFGOOD FZ-LLC, Ras Al Khaimah (AE)

(72) Inventor: João José ALVES FINO, Leiria (PT)

(21) Appl. No.: 17/777,096

(22) PCT Filed: Nov. 21, 2019
(86) PCT No.: PCT/PT2019/050044

§ 371 Date: May 16, 2022

(51) Int. Cl. A47J 43/046; A47J 43/07; A47J 31/42; A47J 31/54; A47J 31/46

(52) U.S. Cl. CPC A47J 43/046; A47J 43/0722; A47J 31/42; A47J 31/54; A47J 31/468

(57) ABSTRACT

The present invention falls within the scope of juice-making machines, namely relating to a natural juice preparation machine from an individual portion of a frozen food preparation, preferably fruits, in a container or a cup (19) that can be coupled to the machine, the latter comprising a digital interface (8) in which the conditions for preparing the juice are pre-set, a grid (10) for placing the container or cup (19), wherein the first step of preparing the juice consists in previously diluting it with water, a blade block (20) detachable from the machine and to which the cup (19) is coupled, with the assembly formed between the blade block (20) and the cup (19) being coupled to a fitting block (12) where the grinding and defrosting of the preparation occurs until the ideal point of consumption has been reached.

### SCOPE AND BACKGROUND OF THE INVENTION

The present invention falls within the scope of juice-making machines, namely relating to a natural juice preparation machine from an individual portion of a frozen food preparation, preferably fruits, in a container that can be coupled to the machine.

The market of machines designed for home and professional use for the preparation of beverages such as coffees, teas and juices has undergone a very fast and versatile transformation in order to satisfy a highly competitive and demanding market. However, a solution combining the quick and easy extraction of a 100% natural juice with a reduced need for post-use cleaning is not yet known.

Therefore, the present invention arises with the need to fill this gap in the market, i.e. a juice preparation machine that allows the preparation of a quality natural juice, without the user having to select the raw material, prepare it and place it in the machine, but rather simply placing a container with a frozen food preparation into the machine. Simultaneously, it was also desired that the solution found could provide a fast cleaning of the equipment between uses and cause minimal waste.

Some of the currently available solutions provide the option to mix and/or crush fruits so as to prepare a juice; however, those are too generic solutions which are not focused on a demanding niche market, being limited only to mixing the solid elements suspended in a volume of liquid, not comprising heating sources aimed at defrosting the frozen foods.

The patent application with the publication number TWM5194667Y discloses a liquid mixer to which an inverted cup is coupled, but differs from the present invention in that it does not have an automatic water addition mechanism, nor a heating source for defrosting the preparation.

The patent application with the publication number TWM298965Y discloses a juice extractor of the blender type, having a blade in the centre of the motor shaft; however, it also differs from the present invention in that it does not have an automatic water addition mechanism, nor a heating source for defrosting the preparation.

The particular characteristic of the present invention is that this machine is designed for the extraction of juices from a frozen fruit preparation. As with other solutions for home or semi-professional machines, such as the machines aimed at making tea, various types of coffees, cappuccino and hot chocolate, there is still no similar solution for providing a 100% natural-quality juice. The present innovation results from the need to satisfy users since the goal was to deliver something guaranteedly healthy and without the addition of food colourings or preservatives, avoiding the need for processes like pasteurisation or pressurisation.

Thus, the present invention has the following advantages comparatively to the state of the art:
a 100%-natural juice is obtained with no added colourings or preservatives;
made from a ready-to-process preparation, without direct handling of food;
minimum waste;
easy cleaning;
convenient and fast system for both home and professional use.

### SUMMARY OF THE INVENTION

It is thus the object of the present invention a machine for preparing natural juices from a frozen food preparation previously packed in a sealed or closed container or cup (19) which, upon removal of a seal or lid, is coupled to the machine.

Thus, the juicer comprises a digital interface (8) and two units that are essential for its operation, these being a pre-dilution unit, comprising:
a water tank (5) inside the machine;
a water pump (4) for pumping the water towards a tubular resistor (3) for heating the water;
a water outlet nozzle (9);
a grid (10) for placing a cup (19);
   and a grinding and heating unit, which comprises:
a fitting block (12) comprising a circular resistor (2) traversed in its centre by a drive shaft (14) of a motor (1);
a blade block (20), which is detachable from the machine, having a snap ring (22), a metal base (21) and on one face of the metal base a cutting blade (24) located in the centre, the blade block being coupled to a cup (19) on the blade side, and the assembly formed by the cup (19) and the blade block (20) simultaneously engaging the fitting block (12) and the drive shaft (14) of a motor (1) located in the centre of the fitting block (12);

The water pre-dilution unit is where the first step of the juice preparation step takes place and it comprises a grid (10) for placing the cup (19), the said unit operating from a water tank (5) located inside the machine, the water from the tank (5) being pumped by a water pump (4) towards a tubular resistor (3) to heat the water which, when heated, will come out at the nozzle (9) for executing the pre-dilution of the preparation contained in the cup (19).

Since this is a frozen preparation, it is necessary to pre-dilute with water in order to obtain a juice. At the same time, this dilution is performed with water at a temperature which may vary from 18 to 85° C., depending on the type of final product to be obtained. This dilution with heated water allows the defrosting process of the concentrate to gradually start, while reducing the required operating time, as well as reducing the motor effort on the grinding unit and extending the life of the cutting blades.

The grinding and heating unit is where the step after the pre-dilution of the preparation occurs. The blade block (20) comprising a blade (24) for grinding the preparation is coupled to the cup (19) containing the previously diluted frozen preparation, and the assembly formed by the cup (19) and the blade block (20) is fitted into the fitting block (12) of the machine.

The fitting block (12) has at its base a circular resistor (2), which is traversed in the centre by a drive shaft (14) of a motor (1) that transmits the rotation of the motor (1) to the blade (24) of the blade block when fitted into the fitting block (12), thus grinding the preparation.

The circular resistor (2) which heats the preparation by conduction heat transfer through a metal base (21) contained in the blade block (20) gradually transforms the frozen preparation into a liquid state, with ideal texture and temperature for consumption. It should be explained that grinding alone is not sufficient to defrost the product. Through tests performed while designing a solution, it was found that the preparation subjected only to grinding resulted in a grated ice juice which was too icy for the consumer, or alternatively, further dilution resulted in a too watery juice, with low intensity of flavour and low concentration of nutrients, thus not presenting the ideal conditions to be consumed.

The blade block (20) is a detachable part of the machine having a snap ring (22), and in one face of the snap ring (22) there is a thermally conductive metal base (21) with a gear at the centre, allowing simultaneous engagement in the drive shaft (14) of the motor (1) and in the fitting block (12). On the opposite face, there is a blade (24) which grinds the preparation inside the cup (19) when the cup (19) is coupled to the blade block (20).

It should be noted that the engagement of the blade block (20) into the fitting block (12) allows not only the transmission of rotation of the drive shaft (14) to the cutting blade (24) but also ensures contact of the thermally conductive metal base (21) with the surface of the resistor (2) thus simultaneously occurring the grinding through the cutting blade (24) and the heat transfer between the resistor (2) and the preparation inside the cup, the said preparation being therefore defrosted and ground.

The machine which is the object of the present invention has a digital interface (8) wherein the juice preparation conditions are pre-set and the instructions for performing the pre-dilution and grinding and heating steps are given.

It is also an object of the present invention a method for the preparation of a juice according to the machine described above, and which comprises the following steps:
a) selection of the juice type in the digital interface (8);
b) placing the open cup (19) of frozen fruit preparation on the grid (10);
c) selection of the dilution operation on the digital interface (8);
d) pre-dilution of the preparation with water at a temperature between 18 and 85° C.;
e) fitting the cup (19) into the blade block (20);
f) fitting the assembly formed between the blade block (20) and the cup (19) into the fitting block (12);
g) selection of the mixing operation which starts grinding and heating the concentrate for 20 to 90 seconds;
h) detaching the assembly formed between the blade block (20) and the cup (19) from the fitting block (12);
i) detaching the blade block (20) from the cup (19);
j) product ready for consumption;
k) washing the blade block (20) for next use.

### DESCRIPTION OF THE FIGURES

FIG. 1—Schematic perspective view of the machine for preparation of juices, and also the publication figure, which comprises a digital interface (8) wherein the conditions for the juice preparation are pre-set, a grid (10) for placing the cup (19) where, in a first step of the juice preparation, a pre-dilution with water contained within the machine is made, a blade block (20) which is detachable from the machine and to which the cup (19) is coupled, with the assembly formed between the block (20) and the cup (19) being coupled to the fitting block (12).

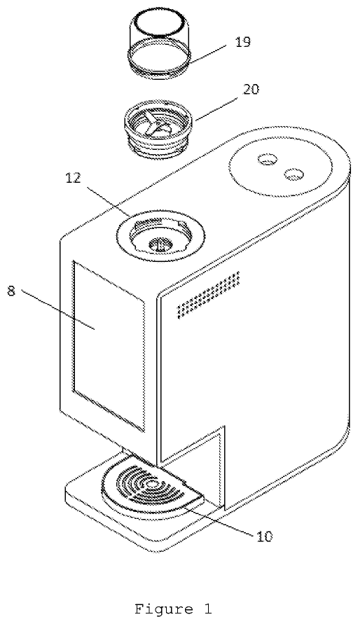

FIG. 2—Representation of a sectional view of the machine which comprises a grid (10) for placing the cup (19), a water tank (5) located inside the machine, the water of the tank (5) being pumped by means of a pump (4) towards a tubular resistor (3) for heating the water which, when heated, will come out at the nozzle (9) for pre-dilution. This figure also presents the cup (19) containing the pre-diluted frozen preparation coupled to the blade block (20), with the assembly formed by the cup (19) and the blade block (20) being fitted into the fitting block (12) having at its base a circular resistor (2) which is traversed in the centre by a drive shaft (14) of a motor (1) with the motor (1) and the circular resistor being attached to the fitting block (12) through a supporting part (13).

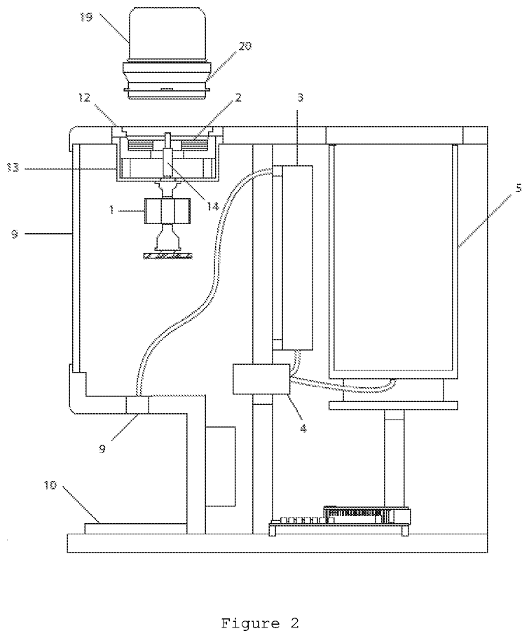

FIG. 3—Schematic representation of the cup (19) coupled to the blade block (20) with a snap ring (22), one metal base (21) being attached to one of its faces and a blade (24) to the opposite side at the centre.

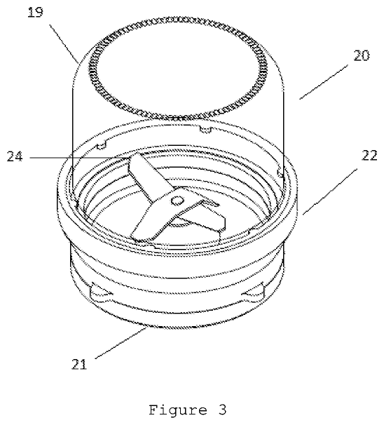

FIG. 4—Exploded view of the elements that make up the blade block (20), which has on one face a metal base (21) screwed to the ring (22) of the blade block (20) containing a sealing ring (23) disposed on its inner perimeter; and on the opposite face, a cutting blade (24), whose shaft crosses the centre of the metal base assisted by a bearing (28) and seals (26 and 27), being screwed by means of a thread to the rotating gear (29), the latter also being assisted by a bearing (25), this set of elements thus allowing rotation of the blade.

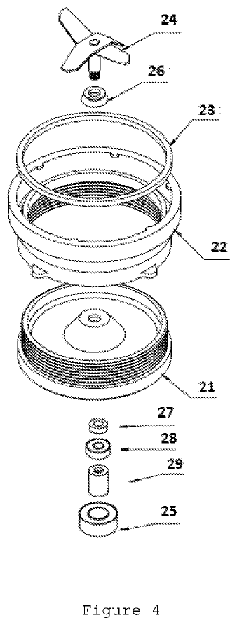

FIG. 5—Schematic perspective view of the machine for preparing juices with the shield (18) placed over the fitting block (12).

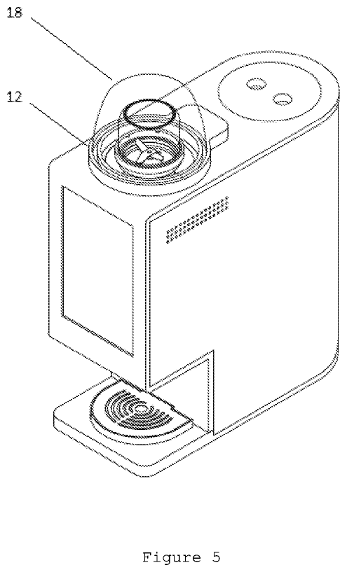

### DETAILED DESCRIPTION OF THE INVENTION

Following a general description of the essential characteristics of the invention, preferred embodiments and possible alternatives for their implementation are herein detailed.

The fitting of the blade block (20) to the fitting block (12) is made by means of a snap ring (22) of the blade block (20) that has tabs on its outer perimeter which engage in concavities located internally on the perimeter of the fitting block (12).

The cup (19) is fitted into the blade block by means of a thread.

The blade block (20), on the face which comprises the blade and to which the cup (19) is coupled, has on its inner perimeter an elastic and leak-free sealing ring (23), preferably made of silicone, which ensures the tightness of the assembly formed between the blade block (20) and the cup (19), thus preventing outward spills.

In a preferred embodiment of the invention the cutting blade (20) is fixed to the blade block (20) through the metal base (21) by means of its shaft, sealed by at least two seals (26) and (27), the blade shaft (20) being guided by a rotation bearing (28), and a rotation gear (29) at the end of the blade shaft (24) that engages the drive shaft (14), therefore providing the transmission of rotation between the motor (1) and the cutting blade (24).

In a preferred embodiment of the invention, the metal base (21) is attached to the snap ring (22) by screwing, due to its ease in assembling the components.

In an alternative embodiment of the invention, the metal base (21) is joined to the snap ring (22) by crimping the components, due to the durability of this type of connection, with sealing preventing the accumulation of bacteria.

The resistor (2) and motor (1) are fixed to the machine frame by means of a supporting part (13), which in turn attaches inferiorly to the fitting block (12), surrounding the resistor (2) and wherein the motor (1) is bolted, which enables a strong and aligned clamping of the motor (1) avoiding vibration and oscillation, as well as thermal insulation of the resistor.

In a preferred embodiment of the invention, the circular resistor (2) is thermally insulated at its perimeter in order to prevent heat conduction up to the surface of the fitting block (12), thus preventing burns to the user.

In an alternative embodiment of the invention, the supporting part (13) is made of rigid, high temperature resistant material, also allowing thermal insulation of the resistor (2) peripherally and subsequently extending the longevity of neighbouring components by reducing heat exposure, as well as providing a rigid, solid and long-lasting fixation.

The insulating material of the supporting part (13) may be a high temperature resistant polymer, such as polytetrafluoroethylene or polyamide.

In a preferred embodiment of the present invention, a shield (18) is placed on the cup (19) when it is coupled to the fitting block (12) for the user's protection and safety. Such shield (18) acts as a safety system, so the machine will not operate without it being in place.

In another preferred embodiment of the invention the motor is in a vertical position relative to the bottom of the machine which rests on a horizontal surface, such as a table, in such a way that when the cup (19) is coupled to the machine it is in an inverted position.

It is also object of the present invention a method for preparing a juice according to the machine described above, and comprising the following steps:
a) selection of the juice type in the digital interface (8);
b) placing the open cup (19) of frozen fruit preparation on the grid (10);
c) selection of the dilution operation on the digital interface (8);
d) pre-dilution of the preparation with water at a temperature between 18 and 85° C.;
e) fitting the cup (19) into the blade block (20);
f) fitting the assembly formed between the blade block (20) and the cup (19) into the fitting block (12);
g) selection of the mixing operation which starts grinding and heating the concentrate for 20 to 90 seconds; h) washing the blade block (20) for next use.

In an alternative embodiment of the invention, the frozen preparation of step b) may be based on frozen legumes and/or vegetables, as well as cocoa or yogurt-based beverages, and milk may be used as an alternative to water. In this way, fruit and/or chocolate shakes can be obtained so as to provide a vegetable juice or even a soup.

In an alternative embodiment of the invention, a shield (18) is put into place after step f).

The disclosed machine, object of the present invention, is used in the preparation of 100% natural juices without the addition of food colourings or preservatives; additionally it can be used in the production of vegetable or vegetable and fruit juices, as well as even in the production of soups from a frozen base, also without the addition of food colourings.

The possible several uses of this invention represent an obvious advantage of the machine in that it does not limit its use to one single product, but to a wider range of products.

The frozen preparation is essentially based on fresh cut frozen food and not on a milled or pre-ground frozen concentrate, thus avoiding early food deterioration and loss of nutritional value.

Additionally, a frozen preparation in the form of frozen food pieces facilitates the entry and circulation of water from the pre-dilution step into the spaces formed between the food pieces, thus ensuring a larger specific surface of food contact, as well as allowing it to be more efficiently defrosted and more easily unsticked from the cup walls.

As will be evident to a person skilled in the art, the present invention should not be limited to the embodiments described herein, with a number of changes being possible, which remain within the scope of this invention.

Of course, the preferred embodiments above described are combinable in the different possible forms, the repetition of all such combinations being herein avoided.

1. A machine for preparing juices from a frozen food preparation, characterized in that it comprises a digital interface, a pre-dilution unit, which comprises:
water tank inside the machine;
a water pump for pumping the water towards a tubular resistor for heating the water;
a water outlet nozzle;
a grid for placing a cup;
and a grinding and heating unit, which comprises:
a fitting block comprising a circular resistor traversed in its centre by a drive shaft of a motor;
a blade block, which is detachable from the machine, having a snap ring, a metal base and on one face of the metal base a cutting blade located in the centre, the blade block being coupled to a cup on the blade side, and the assembly formed by the cup and the blade block simultaneously engaging the fitting block and the drive shaft of a motor located in the centre of the fitting block;

2. A machine according to the previous claim, characterized in that the snap ring of the blade block has tabs on its outer perimeter which engage in concavities located internally on the perimeter of the fitting block.

3. A machine according to claim 1, characterized in that the cup fits into the blade block by means of a thread.

4. A machine according to claim 1, characterized in that the blade block has on its inner perimeter an elastic and leak-free sealing ring preferably made of silicone.

5. A machine according to claim 1, characterized in that the cutting blade is fixed to the blade block through the metal base by means of its shaft, comprising at least two seals and, a rotation bearing and a rotation gear at the end of the blade shaft.

6. A machine according to claims 1, characterized in that the metal base is attached to the snap ring by screwing or pushing it to fit.

7. A machine according to claim 1, characterized in that the metal base is attached to the snap ring by crimping.

8. A machine according to the claim 1, characterized in that the resistor and the motor are fixed to the machine frame by means of a supporting part, which in turn attaches inferiorly to the fitting block, surrounding the resistor and wherein the motor is bolted.

9. A machine according to claim 1, characterized in that the circular resistor is thermally insulated at its perimeter.

10. A machine according to claim 1, characterized in that the supporting part is made of a rigid and high-temperature resistant material.

11. A machine according to claim 1, characterized in that the material of the supporting part is polytetrafluorethylene or polyamide.

12. A machine according to claim 1, characterized in that it comprises a shield placed over the assembly formed between the cup and the blade block when the latter is coupled to the fitting block.

13. A machine according to claim 1, characterized in that the motor is in a vertical position relative to the bottom of the machine which rests on a horizontal surface, in such a way that when the cup is coupled to the machine it is in an inverted position.

14. A method for the production of juice according to the machine disclosed in claim 1, comprising the following steps:
a) selection of the juice type in the digital interface;
b) placing the open cup of frozen fruit preparation on the grid
c) selection of the dilution operation on the digital interface;
d) pre-dilution of the preparation with water at a temperature between 18 and 85° C.;
e) fitting the cup into the blade block;
f) fitting the assembly formed between the blade block and the cup into the fitting block;
g) selection of the mixing operation which starts grinding and heating the concentrate for 20 to 90 seconds;
h) washing the blade block for next use.

15. A method according to claim 14, characterized in that the frozen preparation of step b) is made from frozen vegetables and/or legumes.

16. A method according to claim 14, characterized in that a shield is put into place after step f).

17. Use of the machine disclosed in claim 1 for the production of fruit and vegetable natural juices and of soups, as well as of cocoa or yogurt-based beverages, wherein milk may be used as an alternative to water.
